(19) United States
(12) Patent Application Publication
(10) Pub. No.: US 2005/0289135 A1
(43) Pub. Date: Dec. 29, 2005

(54) Text mining server and program

(75) Inventor: Yuji Morikawa, Tokyo (JP)

Correspondence Address: Reed Smith Hazel & Thomas LLP;Suite 1400, 3110 Fairview Park Drive, Falls Church, VA, 22042-4503, US

(73) Assignee: Hitachi Software Engineering Co., Ltd.

(21) Appl. No.: 11/157,918

(22) Filed: Jun. 22, 2005

(30) Foreign Application Priority Data
Jun. 29, 2004 (JP) 2004-191915

(51) Int. Cl. G06F 17/30

(52) U.S. Cl. 707/4

(57) ABSTRACT

When the characteristics of the entire gene group consisting of a plurality of genes are to be grasped, the tendency that the characteristics of a gene having a large number of documents become dominant can be avoided. A plurality of search keys are accepted from a client, and a set of document groups each corresponding to the plurality of the accepted search keys is obtained by searching a database in which corresponding relationships between the search keys and the document groups are recorded. Next, an associative search is performed on a document database with respect to each of the search keys using the obtained document groups as keys to obtain a new set of document groups including the obtained document groups. Characteristic words are extracted from the new set of document groups, and a characteristic word list is sent to the client as mining results.

### CLAIM OF PRIORITY

The present application claims priority from Japanese application JP 2004-191915 filed on Jun. 29, 2004, the content of which is hereby incorporated by reference into this application.

### BACKGROUND OF THE INVENTION

1. Field of the Invention

The present invention relates to a text mining server and a text mining program for analyzing experimental results in life science fields.

2. Background Art

In the life science fields, much of information is stored as documents in a text-format, and it has become difficult for users to reach information that is really necessary due to large quantities thereof. In recent years, with the improvement of text mining technologies, means for performing text mining on such documents in a text-format to obtain useful information has been widely used. An application thereof includes an analysis of experimental results of microarrays. The analysis of experimental results of microarrays includes grasping the characteristics of as many as tens to hundreds of genes in some form. In order to realize the analysis, one method obtains related document information in each gene and performs text mining on the entire document group that has been obtained. A search is performed to obtain document information using a KeyID assigned to each gene (known genes are registered in a public database and unique IDs are assigned thereto).

In conventional text mining, the KeyID is transmitted from a client computer to a server computer. The server computer compares the received KeyID with a KeyID/document link table and obtains a document list related to the KeyID. Next, a characteristic word list is obtained from the text of documents included in the obtained document list, using a characteristic word extraction program. The characteristic word list is transmitted to the client computer, and then the client computer receives and displays the transmitted mining results, thereby ending the mining. Documents related to the text mining include the following Patent Document 1.

Patent Document 1: JP Patent Publication (Kokai) No. 2004-152035 A

### SUMMARY OF THE INVENTION

The conventional text mining mentioned above has the following problems.

1. The number of related documents is different in each gene. Thus, when the characteristics of the entire gene group consisting of a plurality of genes are to be grasped, the characteristics of a gene having a large number of documents become inevitably dominant.

2. When a related document group is obtained in each gene, a link table of genes and document information is not necessarily updated. Thus, it is possible to obtain limited, erroneous, or past document information.

It is an object of the present invention to provide a text mining method in which the problems of the prior art are reduced.

In order to achieve the aforementioned object, a text mining server of the present invention comprises search key accepting means for accepting a plurality of search keys and means for searching a database in which corresponding relationships between the search keys and document groups are recorded and for obtaining a set of document groups each corresponding to the plurality of the accepted search keys. The text mining server further comprises associative search means for performing an associative search on a document database with respect to each of the plurality of the accepted search keys using the obtained document groups as keys and for obtaining a new set of document groups including the obtained document groups, characteristic word list preparation means for extracting characteristic words from the new set of document groups obtained via the associative search means and for preparing a characteristic word list, and output means for outputting the characteristic word list as mining results.

The number of documents obtained in each search key via the associative search means may be set in advance. The output means may be adopted to output a list of documents obtained via the associative search means as mining results along with the characteristic word list.

The functions of the text mining server are realized by a computer program.

According to the present invention, document information used to extract the entire characteristics is adjusted such that the number of documents in each KeyID is a constant standard, so that more correct characteristics can be captured. Moreover, related documents are retrieved when the number of documents is adjusted, so that related documents that cannot be captured using the link table of KeyID/document information can also be obtained.

### BRIEF DESCRIPTION OF THE DRAWINGS

FIG. 1 shows a conceptual diagram of a text mining system according to the present invention.

FIG. 2 shows an example of a KeyID/document link table.

FIG. 3 shows an example of document information.

FIG. 4 shows a correspondence table of the numbers of documents after associative search.

FIG. 5 shows an example of a screen of a KeyID transmission program.

FIG. 6 shows an example of a screen of a mining results reception program.

FIG. 7 shows an image diagram of the input/output of an associative search performing program.

FIG. 8 shows an example of a flow chart of an associative search performing program.

FIG. 9 shows an example of a flow chart of text mining according to the present invention.

FIGS. 10A and 10B show an illustration to describe the difference between a conventional text mining method and the method of the present invention.

FIG. 11 shows an illustration to compare a conventional method and the present invention using screens of a mining results reception program.

### DESCRIPTION OF THE PREFERRED EMBODIMENTS

In the following, an embodiment of the present invention is concretely described with reference to the drawings.

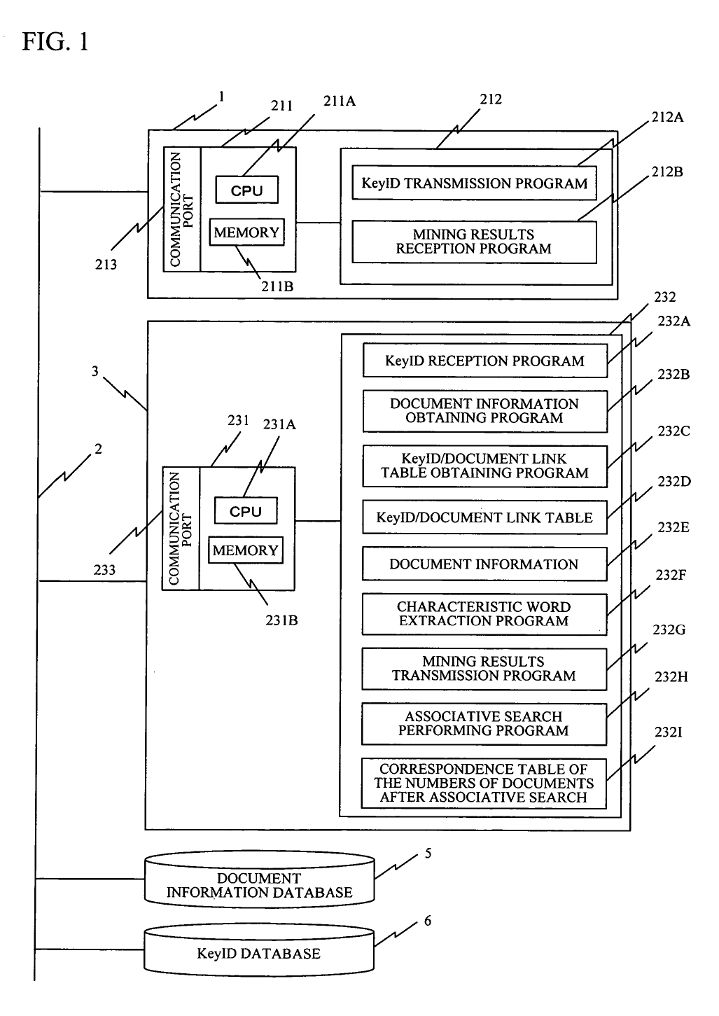

FIG. 1 shows a conceptual diagram of a text mining system according to the present invention. The system shown in this case comprises a client computer 1 (hereafter simply referred to as a client) for inputting and transmitting a KeyID and receiving mining results, a text mining server computer 3 (hereafter simply referred to as a server) for performing text mining, a document information database 5 for holding document information, and a KeyID database 6 for holding a relation table (or information to be used as a basis of preparation thereof) of a KeyID and document information. Each element is connected via a network 2.

The client 1 comprises a terminal device 211 provided with a CPU 211A and a memory 211B, a hard disk device 212 where a KeyID transmission program 2,12A and a mining results reception program 212B are stored, and a communication port 213 for connecting to a network. The server 3 comprises a terminal device 231 provided with a CPU 231A and a memory 231B, a hard disk device 232 to store a KeyID reception program 232A for receiving the KeyID transmitted from the client 1, a document information obtaining program 232B for obtaining document information from the following document information 232E using the KeyID, a KeyID/document link table obtaining program 232C for obtaining the following KeyID/document link table from the KeyID database 6, a KeyID/document link table 232D where the corresponding relationship between the KeyID and document information is registered, document information 232E where document information such as gene-related information is registered, a characteristic word extraction program 232F for extracting characteristic words from a document obtained from the document information 232E, a mining results transmission program 232G for transmitting the results of text mining, an associative search performing program 232H for performing an associative search on the document information 232E on the basis of the characteristic words extracted via the characteristic word extraction program 232F, and a correspondence table 2321 of the numbers of documents after associative search, and a communication port 233 for connecting to the network. The document information 232E is information of the document information database 5, and it is held in the server. The KeyID/document link table 232D is obtained (prepared) from the KeyID database 6 for holding the relation table (or information to be used as a basis of preparation thereof) of the KeyID and document information using the KeyID/document link table obtaining program 232C and the KeyID/document link table 232D is held in the server. In practice, information used for text mining is held locally from the databases connected to the network in this manner.

Also, associative search is a method for retrieving a document by which a document or a document group is used as a key and a document similar to such document or document group is retrieved. The technique of associative search per se is disclosed by JP Patent Publication (Kokai) No. 2002-358315 A, for example. An associative search performing program of the present invention employs a known associative search technique.

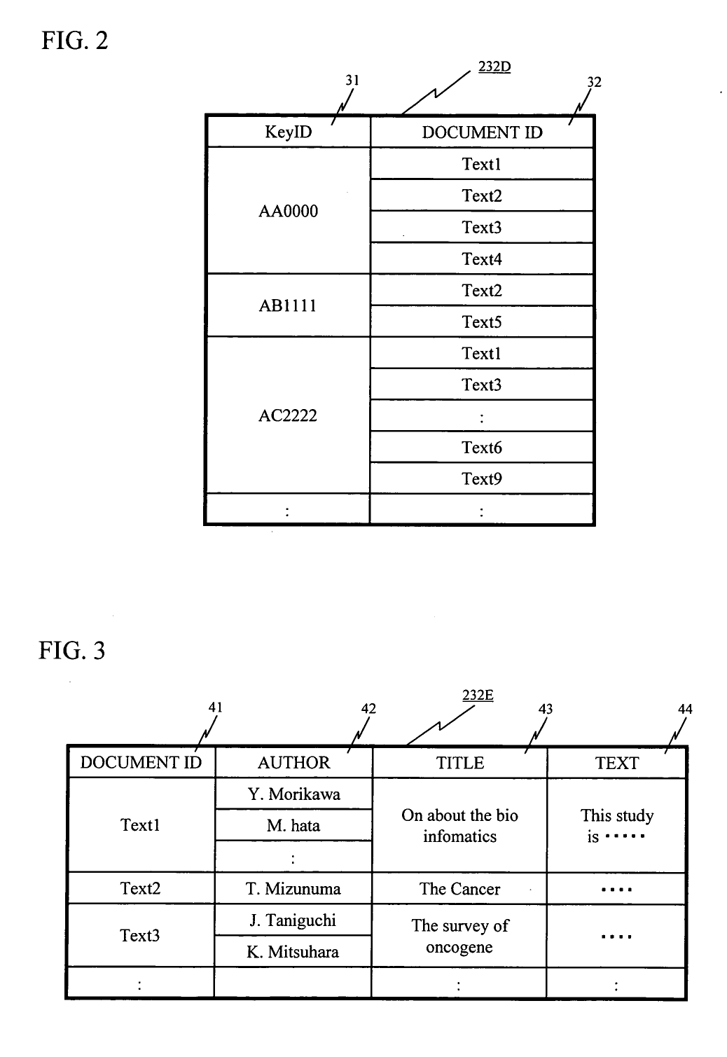

FIG. 2 shows an example of the KeyID/document link table 232D stored in the hard disk device 232 of the server 3. Groups of KeyIDs 31 and document IDs 32 relating to each KeyID are stored. In the table, for example, regarding a gene having a KeyID of “AA0000”, four documents, namely, “Text 1”, “Text 2”, “Text 3”, and “Text 4” are registered as documents related thereto. Regarding a gene having a KeyID of “AB1111”, two documents, namely, “Text2” and “Text5” are registered as documents related thereto.

FIG. 3 shows an example of the document information 232E stored in the hard disk device 232 of the server 3. In the document information 232E, groups of document IDs 41, authors 42 of each document ID, titles 43, and text 44 are stored. The document IDs 41 correspond to the document IDs 32 of FIG. 2. In this example, although the authors, titles, and text are stored as document information, other information such as abstracts and published years, for example, may be stored as document information.

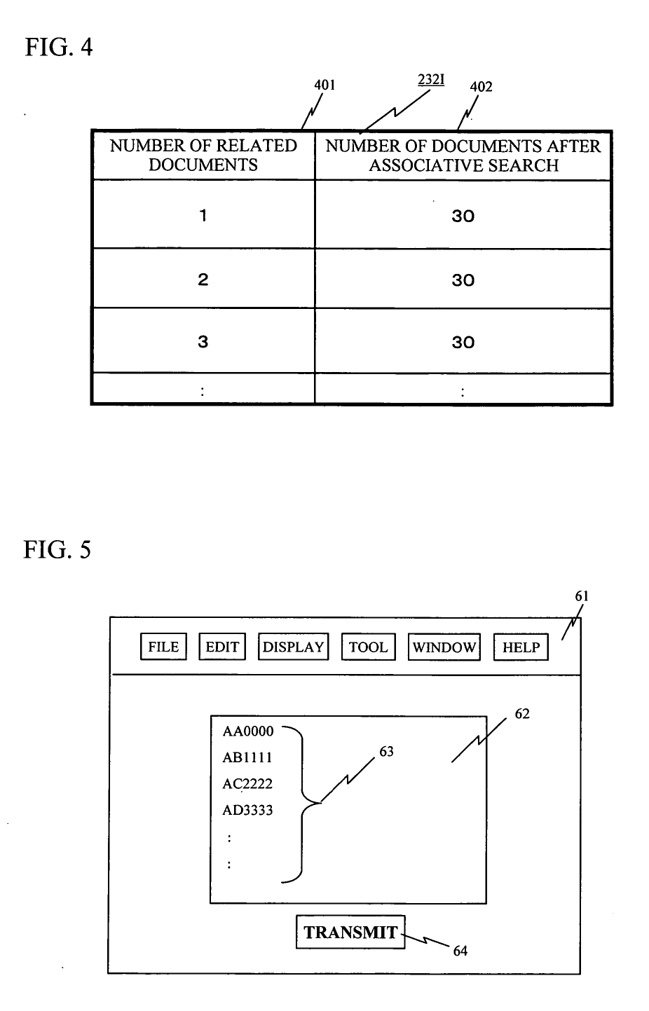

FIG. 4 shows an example of the correspondence table 2321 of the numbers of documents after associative search, the table being stored in the hard disk device 232 of the server 3. The numbers 401 of related documents correspond to the numbers of documents related to each of the KeyIDs of the KeyID/document link table 232D. In most cases, the numbers 402 of documents after associative search have a fixed value (the maximum value of the number of related documents+5, for example). However, a determination method thereof may be arbitrary as long as “a constant standard is determined”. Also, the numbers 402 of documents after associative search is set such that it does not exceed a value set on the basis of an observed value.

FIG. 5 shows an example of a screen of the KeyID transmission program 212A operating on the client 1. A menu 61, a KeyID input field 62, and a transmission button 64 are displayed on the screen. When KeyIDs are inputted into the KeyID input field 62 (They are inputted as shown by numeral 63, for example. A plurality of KeyIDs may be inputted), by pressing down the transmission button 64, the inputted KeyIDs 63 is transmitted to the server 3.

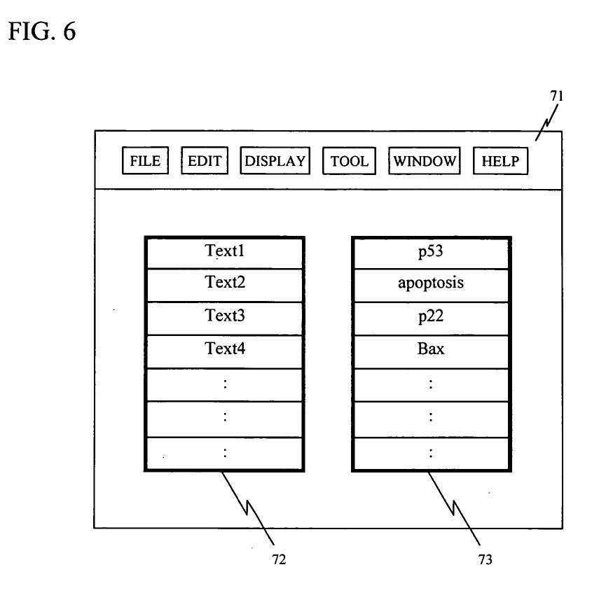

FIG. 6 shows an example of a screen of the mining results reception program 212B operating on the client 1. The screen is displayed when mining results are transmitted from the server 3. A menu 71, a document list 72 of the mining results and a characteristic word list 73 of the mining results are displayed on the screen.

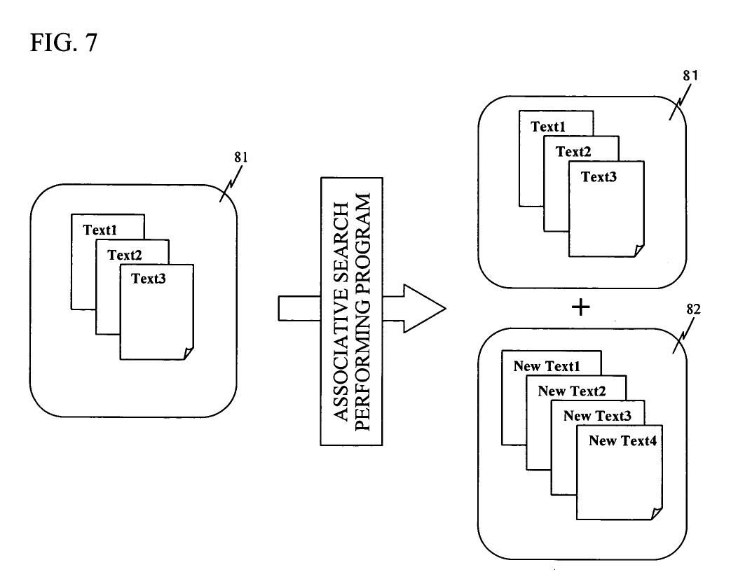

FIG. 7 shows a conceptual diagram representing the input/output of the associative search performing program 232H operating on the server 3. By performing the associative search performing program on a document group 81, the input documents 81 and a new document group 82 related to the input documents 81 can be obtained.

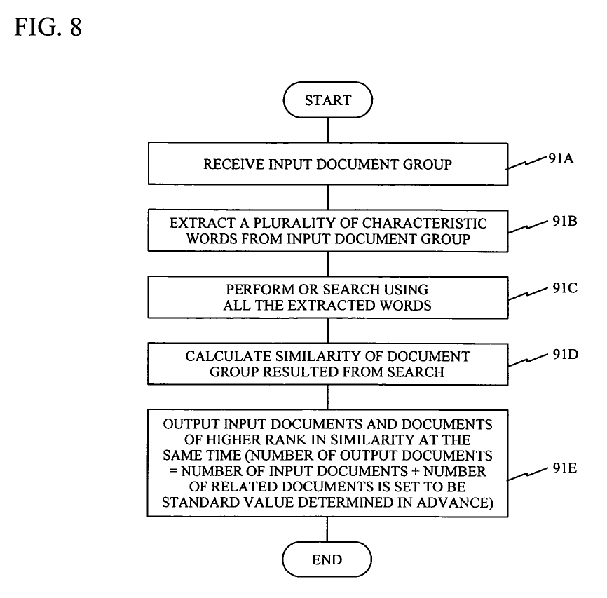

FIG. 8 shows an example of a flow chart of the associative search performing program 232H operating on the server 3. When the program is initiated, first, an input document group related to one KeyID is received (step 91A). Next, a characteristic word list is obtained from the input document group using the characteristic word extraction program 232F (step 91B). The characteristic word list is a list of words that characterize a document list and an extraction method thereof is arbitrary. Examples include a method that employs tf (Term Frequency) and idf (Inverse Document Frequency) widely used in the field of text mining. The tf and idf is a method in which when T(W) represents the total number of documents that include a word W, N represents the total number of documents, and F(W, Q) represents the frequency of appearance of the word W in a document Q, the importance of the word W in the document Q is defined by “F(W, Q)*Log[N/T(W)]”. F(W, Q) corresponds to the tf, and Log[N/T(W)] corresponds to the idf.

Next, the characteristic words in the extracted characteristic word list are connected with OR, and a document search is performed on the document information database 5 to narrow candidates of related documents (step 91C). The similarity of each document of the results of the OR search and the input document group is calculated (step 91D). An algorithm for calculating the similarity used in step 91D may be arbitrary. For example, the SMART method widely employed in the field of similar document search is used. Finally, the input document group and documents of the higher rank in the similarity are outputted at the same time (step 91E). In this occasion, the number of output documents (=the number of input documents+the number of related documents) is set to be a standard value determined in advance in accordance with the correspondence table 2321 of the numbers of documents after associative search in FIG. 4. In this manner, as in the case of “AB1111” shown in FIG. 2, for example, even if the number of documents registered in relation to the KeyID is as small as two, it is adjusted to be the number of documents that is equal to a standard determined in advance (30 documents in the example of FIG. 4).

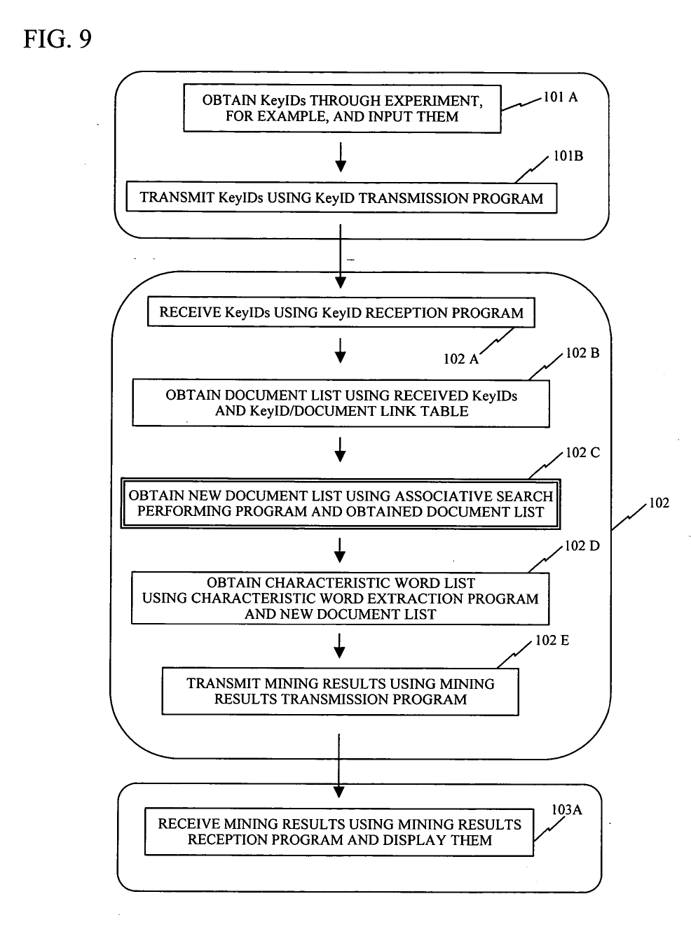

FIG. 9 shows an example of a flow chart of mining using a text mining system improved in accordance with the present invention. The flow chart corresponds to a conventional text mining process in which step 102C for performing associative search is inserted.

First, a plurality of KeyIDs are inputted in the client 1 (step 101A), and mining is initiated by transmitting the plurality of inputted KeyIDs to the server 3 (step 101B). The server 3 receives the transmitted KeyIDs (step 102A), and obtains related documents in each KeyID by comparing the received KeyIDs with the KeyID/document link table 232D (FIG. 2) (step 102B). In the following step 102C, the associative search performing program 232H is performed on the related documents of each KeyID and the numbers of related documents in each KeyID are adjusted to be the numbers of documents after associative search shown in FIG. 4. In this manner, a new document list is obtained. With respect to KeyIDs such that the numbers of documents registered in the KeyID/document link table (FIG. 2) exceed the numbers of documents after associative search shown in FIG. 4, the number of documents is not increased through the associative search.

Next, a characteristic word list is obtained (step 102D) using the characteristic word extraction program and a document list in which related documents relative to all KeyIDs are merged. The characteristic word list is a list of words that characterize the document list and is obtained using the tf and idf method, for example. The server 3 finally transmits the document list and the characteristic word list to the client 1 as mining results (step 102E). The client 1 receives and displays the transmitted mining results (step 103A), thereby ending the mining.

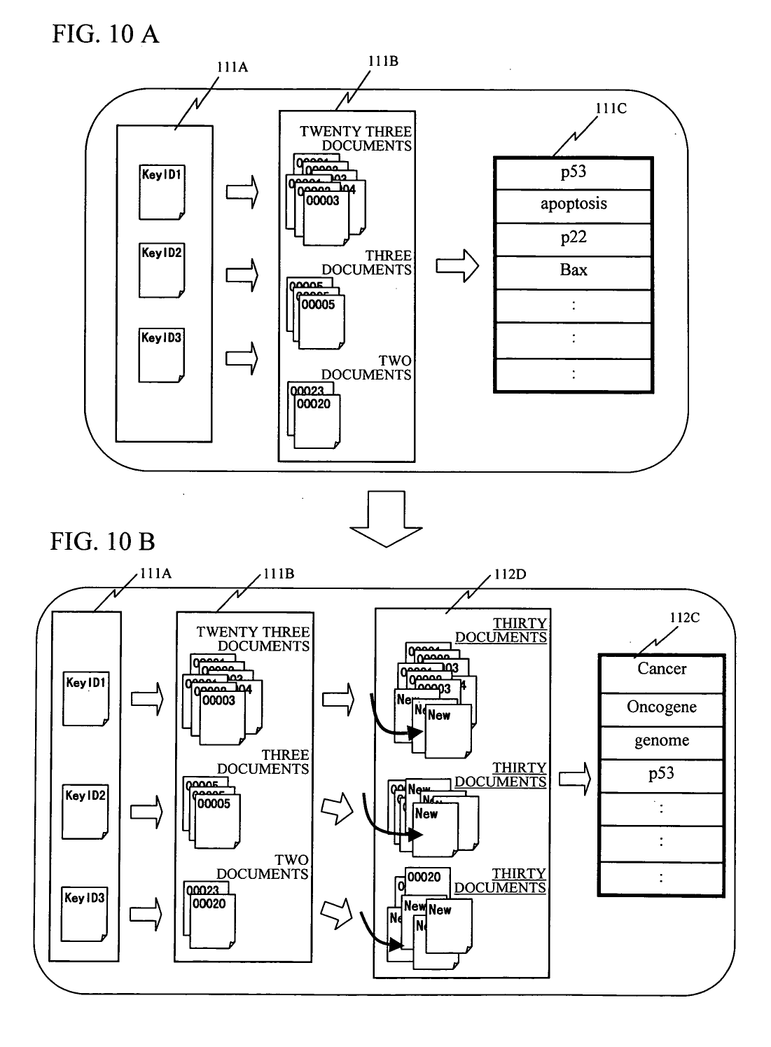

FIGS. 10A and 10B show an illustration to describe the difference between conventional text mining and the text mining of the present invention having a step where the numbers of documents are adjusted in each KeyID through associative search. FIG. 10B corresponds to a portion of a flow chart (the process of 102 in FIG. 9) of the text mining in the present invention, and FIG. 10A corresponds to a portion of a flow chart (the process of 102 in FIG. 9 in which step 102C is eliminated) of the conventional text mining. In the illustration, a KeyID group 111A includes KeyIDs received by the server 3 from the client 1. A related document group 111B is a document list obtained by the server 3 using the received KeyIDs and the KeyID/document link table. Twenty three documents are extracted relative to KeyID1, three documents are extracted relative to KeyID2, and two documents are extracted relative to KeyID3. A characteristic word group 111C is mining results transmitted to the client 1 by the server 3 in the conventional text mining. The second related document group 112D is a document list obtained via the associative search of the present invention shown in step 102C of FIG. 9. Further, a characteristic word group 112C is mining results transmitted to the client 1 by the server 3 in the text mining of the present invention.

In FIG. 10A, characteristic words are extracted relative to the document group 111B. However, the number of documents is greatly different in each KeyID (KeyID1 has twenty three documents, KeyID2 has three documents, and KeyID3 has two documents), so that most of the extracted characteristic word list 111C represents the characteristics of KeyID1 (p53, for example). By contrast, in the present invention shown by FIG. 10B, the associative search performing program 232H is performed on the first related document group 111B, and characteristic words are extracted from the second related document group 112D in which the number of documents is adjusted in each KeyID. As a result of the numbers of documents that have been adjusted, the characteristics (p53) of KeyID1 alone has moved down in the list and the entire characteristics (Cancer) has come to the top.

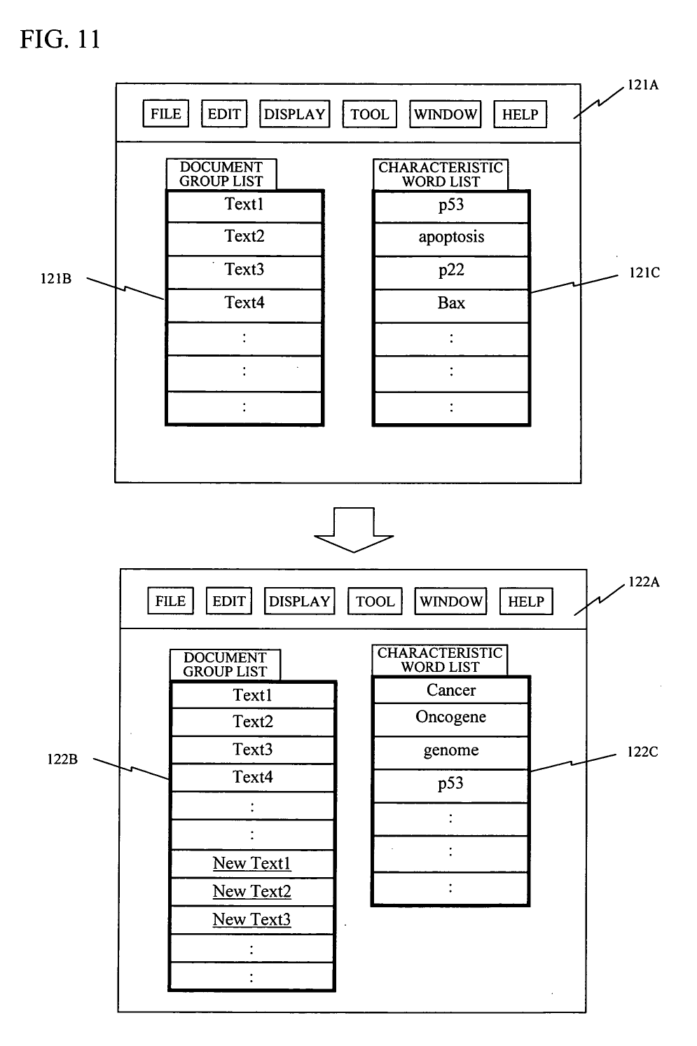

FIG. 11 shows an illustration to compare the conventional technique and the present invention using screens of the mining results reception program 212B operating on the client 1. Reference 121A shows an example of a screen displaying results via the conventional mining method, and reference 122A shows an example of a screen displaying results via the mining method of the present invention. Reference 121B represents a document group list according to the conventional technique, and reference 122B represents a document group list according to the present invention. Also, reference 121C represents a characteristic word list according to the conventional technique, and reference 122C represents a characteristic word list according to the present invention. Reference 122B shows that a new related document group (New Text1, for example) is obtained as compared with reference 121B. Also, reference 122C shows the entire characteristics of KeyIDs as compared with reference 121C.

1. A text mining server comprising:
search key accepting means for accepting a plurality of search keys;
means for searching a database in which corresponding relationships between the search keys and document groups are recorded and for obtaining a set of document groups each corresponding to the plurality of the accepted search keys;
associative search means for performing an associative search on a document database with respect to each of the plurality of the accepted search keys using the obtained document groups as keys and for obtaining a new set of document groups including the obtained document groups;
characteristic word list preparation means for extracting characteristic words from the new set of document groups obtained via the associative search means and for preparing a characteristic word list; and
output means for outputting the characteristic word list as mining results.

2. The text mining server according to claim 1, wherein the number of documents to be obtained in each search key via the associative search means is set in advance.

3. The text mining server according to claim 2, wherein the output means outputs a list of documents obtained via the associative search means as mining results along with the characteristic word list.

4. The text mining server according to claim 1, wherein the search key accepting means receives a plurality of search keys from a client computer and the output means transmits the mining results to the client computer.

5. The text mining server according to claim 1, wherein the search key comprises an identifying symbol for specifying a gene.

6. A text mining program for enabling a computer to function as:
search key accepting means for accepting a plurality of search keys;
means for searching a database in which corresponding relationships between the search keys and document groups are recorded and for obtaining a set of document groups each corresponding to the plurality of the accepted search keys;
associative search means for performing an associative search on a document database with respect to each of the plurality of the accepted search keys using the obtained document groups as keys and for obtaining a new set of document groups including the obtained document groups;
characteristic word list preparation means for extracting characteristic words from the new set of document groups obtained via the associative search means and for preparing a characteristic word list; and
output means for outputting the characteristic word list as mining results, for the purpose of performing text mining.

7. The text mining program according to claim 6, wherein the number of documents to be obtained in each search key via the associative search means is set in advance.

8. The text mining program according to claim 7, wherein the output means outputs a list of documents obtained via the associative search means as mining results along with the characteristic word list.

9. The text mining program according to claim 6, wherein the search key comprises an identifying symbol for specifying a gene.

10. The text mining server according to claim 2, wherein the search key accepting means receives a plurality of search keys from a client computer and the output means transmits the mining results to the client computer.

11. The text mining server according to claim 3 wherein the search key accepting means receives a plurality of search keys from a client computer and the output means transmits the mining results to the client computer.

12. The text mining server according to claim 2, wherein the search key comprises an identifying symbol for specifying a gene.

13. The text mining server according to claim 3, wherein the search key comprises an identifying symbol for specifying a gene.

14. The text mining server according to claim 4, wherein the search key comprises an identifying symbol for specifying a gene.

15. The text mining server according to claim 10, wherein the search key comprises an identifying symbol for specifying a gene.

16. The text mining server according to claim 11, wherein the search key comprises an identifying symbol for specifying a gene.

17. The text mining program according to claim 7, wherein the search key comprises an identifying symbol for specifying a gene.

18. The text mining program according to claim 8, wherein the search key comprises an identifying symbol for specifying a gene.
